(19) United States
(12) Patent Application Publication
(10) Pub. No.: US 2004/0086263 A1
(43) Pub. Date: May 6, 2004

(54) System for maintaining history of multimedia content and method thereof

(76) Inventor: Jitesh Arora, Thornhill (CA)

Correspondence Address: TOLER & LARSON & ABEL L.L.P., 5000 PLAZA ON THE LAKE STE 265, AUSTIN, TX, 78746, US

(21) Appl. No.: 10/284,737

(22) Filed: Oct. 31, 2002

(51) Int. Cl. H04N 5/783

(52) U.S. Cl. 386/69; 386/70; 386/83

(57) ABSTRACT

A system and method for maintaining a history of multimedia content and method are disclosed herein. A video stream being is recorded spanning several different programs. A monitoring program identifies changes in programming in the video stream being recorded. Program information for each of the programs in the video stream being recorded are stored in memory and linked to associated programs in the recorded video stream. The stored program information is provided to allow a user to assess and select programs stored in the recoded video stream for playback.

### FIELD OF THE DISCLOSURE

The present disclosure relates generally to recording multimedia data and more particularly to recording multiple multimedia programs.

### BACKGROUND

A plurality of multimedia programming is available to the public. Consumers generally have access to multimedia programming through broadcast programs, either by terrestrial transmissions, cable television, satellite transmissions, or the Internet. However, people are not always able to watch all the programs they want to watch. Video recording devices, such as video-cassette recorders, or digital video recording devices, are available for consumers to record programs when they are away during the programs' scheduled broadcast. Such recording devices allow users to watch recorded programs at a later time, at the users' convenience. Recorded content is stored for playback at a later time, or for time-shifted playback, in which recorded content is played back at a delayed time.

When a plurality of programs are recorded in a single recording, it becomes cumbersome for a user to search through the recorded video stream to find a particular program. Generally a user has to search by playing different portions of the recorded video stream to find the particular program. Recording devices that are preset to record discrete programs pre-selected by a user, can display the name of discretely recorded programs, allowing users to select specific programs for playback. However, when a user records multiple programs on a single recording or changes channels while recording, no information on the different programs that were recorded is provided to the user during playback. From the above discussion, it should be apparent that an improved method of providing recorded material to a user is needed.

### BRIEF DESCRIPTION OF THE DRAWINGS

Specific embodiments of the present disclosure are shown and described in the drawings presented herein. Various advantages, features and characteristics of the present disclosure, as well as methods, operations and functions of related elements of structure, and accommodation of parts and economies of manufacture, will become apparent upon consideration of the following description and claims with reference to the accompanying drawings, all of which form a part of this specification, and wherein:

FIG. 1 is a block diagram illustrating a system for storing program information associated with portions of a recorded video stream is shown, according to one embodiment of the present disclosure;

FIG. 2 is a block diagram of a graphical user interface for providing program information to a user during a playback of a recorded video stream, according to one embodiment of the present disclosure;

FIG. 3 is a block diagram illustrating the system of FIG. 1 in more detail, according to one embodiment of the present disclosure;

FIG. 4 is a flow diagram illustrating a method of recording a video stream, according to one embodiment of the present disclosure; and

FIG. 5 is a flow diagram illustrating a method of identifying changes in programming associated with a video stream being recorded, according to one embodiment of the present disclosure.

### DETAILED DESCRIPTION OF THE FIGURES

At least one embodiment of the present disclosure provides for a method of recording a received video stream. Received portions of the received video stream are stored as a recorded video stream. The method includes associating a first portion of the recorded video stream with a first identifier. The first identifier is generated to uniquely identify the first portion of the received video stream in the recorded multimedia stream. For example, the first identifier can include a timestamp, date and time, or location of the first portion of the received video stream stored in the first recorded video stream. The first identifier can be used for later identifying the first portion of the recorded video stream during playback. The method includes detecting a change in programming associated with the received video stream. The change in programming represents a change from the first portion of the received video stream and the second portion of the received video stream. For example, the first portion of the received video stream can represent a first program and the second portion of the received video stream can represent a second program, different from the first program. Accordingly, the change in programming can be due to a new detected program, a change in connector used to receive the video stream being recorded or a change in channel being recorded. In one embodiment, a change in programming is identified after thirty minute video segments. The method includes associating a second portion of the recorded video stream with a second identifier. The second identifier is used to uniquely represent the second portion of the received video stream recorded. The method allows program information to be associated with each of the identifiers. The program information can include a program name, a channel name, content rating, program duration or other program characteristic. Accordingly, the program information for particular programs stored in the recorded video stream to be provided to a user for identifying programs stored in the recorded video stream. An advantage of at least one embodiment of the present disclosure is that a user can uniquely identify separate programs stored in a recorded multimedia stream without excessive scanning of the recorded video stream required f the user.

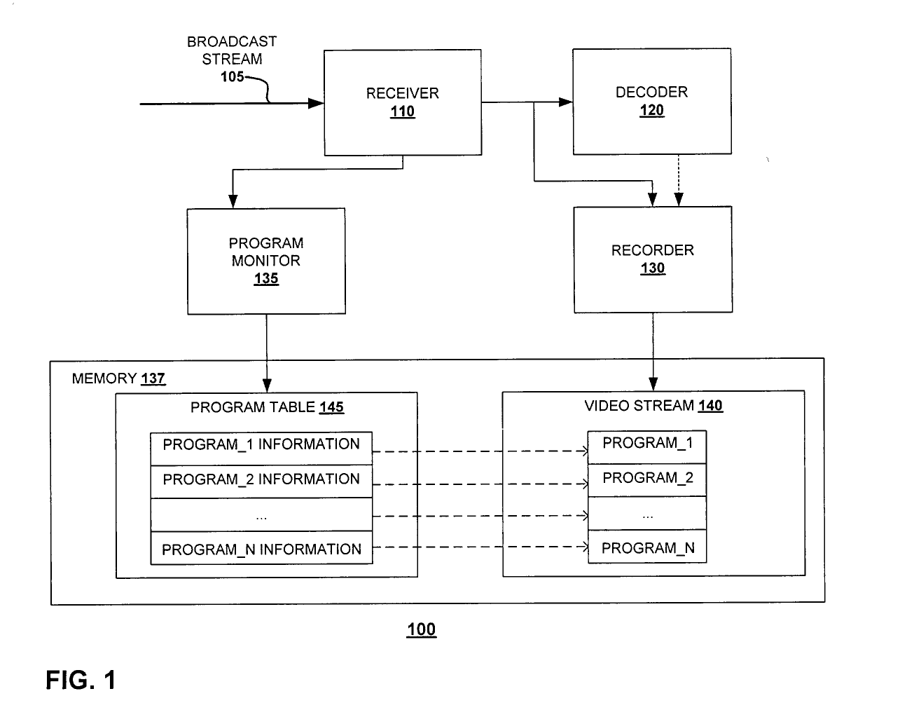

Referring now to FIG. 1, a block diagram illustrating a system for storing program information associated with portions of a recorded video stream is shown and referenced generally as system 100, according to one embodiment of the present disclosure. System 100 includes a receiver 110, a decoder 120, a recorder 130, a program monitor 135 and memory 137. System 100 stores data associated with a broadcast stream 105 as video stream 140 in memory 137. System 100 detects changes in programming associated with the video stream 140 and tracks the changes in program table 145. In one embodiment, the program table 145 is part of a file or a database. Furthermore, memory 137 can be a part of a file or database.

Receiver 110 is used to select at least a single channel of broadcast stream 105. In one embodiment, broadcast stream 105 includes a plurality of video channels. The receiver 110 is used to provide a specific channel of broadcast stream 105. Receiver 110 can include an analog tuner used to select a channel from an analog broadcast, a digital transport stream demultiplexor used to identify data packets associated with a particular channel from a digital transport stream, or other device used to identify a particular multimedia channel.

Decoder 120 is used to generate multimedia data, such as audio and video data, based on the particular channel tuned by the receiver 110. The decoder 120 can include a video demodulator, such as an analog video demodulator or a digital video Motion Pictures Experts Group (MPEG) decoder used to generate video and audio data. The audio and video data generated by the decoder 120 can be further processed for presentation, such as for output to a display device (not shown).

In one embodiment, the video data processed by receiver 110 is stored by recorder 130 for playback and/or processing, such as by decoder 120, at a later time. Recorder 130 stores the video data as video stream 140 in memory 137. Accordingly, a user of system 100 can select video stream 140 for playback at a later time. Alternatively, video stream 140 can be used for time-shifted playback, in which an application is used for playback of video stream 140 at a controlled time, based on when the audio and video data generated by decoder 120 were scheduled for playback.

Recorder 130 can include an application or device to store video stream 140. Recorder 130 can include a digital multimedia recorder used to store the video stream 140 as a digital file in a form of memory storage media, such as a hard disk, or compact disk (CD). Alternatively, recorder 130 can provide analog storage of analog video and audio data generated in an analog storage media, such as a video-cassette tape. Recorder 130 can also be used to provide storage of the audio and video data generated by decoder 120 in memory 137.

In one embodiment, the video stream 140 stored by the recorder 130 includes a plurality of programs, illustrated as Program_{—}1, and Program_{—}2 through Program_N. It should be appreciated that more or less programs can be included without departing from the scope of the present invention. Different programs recorded can be attributed to a change in programming on a single tuned channel, a change in the tuned channel, or a selection of a different signal source (not shown), such as by selecting an alternate broadcast stream, in comparison to broadcast stream 105, or an alternate receiver (not shown) or alternate decoder (not shown).

Program monitor 135 is used to monitor the changes in programs being recorded in the video stream 140 and program information associated with the different programs. The program monitor 135 can monitor the channels tuned by the receiver 110 to determine a change in programming. For example, the program monitor 135 can monitor channels selected by a user. The program monitor can monitor program information to determine a change in programming. Program monitor 135 can monitor the program name or program description. For example, the program monitor 135 can identify program information from data provided by the broadcast stream 105, the particular channel tuned by the receiver 110, or from an alternate source, such as an electronic program guide queried from the Internet, or other information network.

The program monitor 130 stores the program information, such as in program table 145 of memory 137. Program monitor 135 can generate separate sets of program information for each program stored in video stream 140, such as Program_{—}1 information, and Program_{—}2 information through Program_N information. In one embodiment, program monitor 135 also stores links to portions of the stored video stream 140 associated with particular programs. The Program_{—}1 information stored in the program table 145 can be linked to the Program_{—}1 stored in the video stream 140. For example, the program information can be linked to a date/time, timestamp, or memory address associated with each of the individual programs stored in the video stream 140. The type of link used should be selected to allow the program information to be uniquely linked to the associated program in the video stream 140. In one embodiment, video stream 140 includes a circular buffer for handling time-shifted playback. Accordingly, program table 145 can also be generated as a circular buffer to ensure that expired audio and video data overwritten in the video stream 140 is removed from the program table 145. Alternatively, portions of the program table 145 which represent expired programs in the video stream 140 can be monitored and removed.

During playback or scanning of particular portions of the video stream 140, the linked program information 145 can be provided to a user to identify the current program being played or scanned. Alternatively, the set of program information stored in program table 145 can be provided to the user to allow the user to quickly identify programs stored in the video stream 140. The user can also select a program to be played from the program table 145 and the associated portion of the video stream 140 can be provided in response to the program selected by the user.

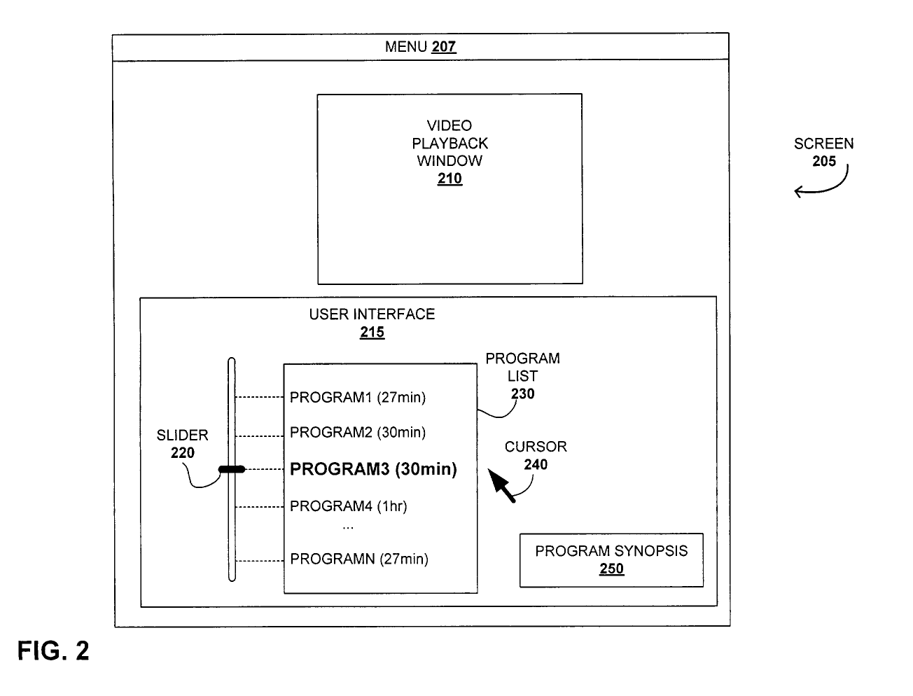

Referring now to FIG. 2, a block diagram of a graphical user interface for providing program information to a user during a playback of a recorded multimedia stream is shown, according to one embodiment of the present disclosure. In the illustrated embodiment, a screen 205 is used for playback of a previously recorded video stream, such as video stream 140 (FIG. 1). The video stream is played back on a video playback window 210. A particular video stream to be played back can be selected through a menu 207 which can provide further options, such as a particular video stream file to load through the use of pull-down menus (not shown). A user interface 215 is used to provide information to a user for accessing portions of the video stream to be played back on the video playback window 210.

User interface 215 is used to provide information associated with individual programs stored as part of the video stream to be played back. For example, user interface 215 includes a program list 230. Program list 230 provides a listing of different programs stored in the video stream to be played back. In one embodiment, once a particular file is selected for playback, associated program information, such as program table 145 (FIG. 1), can be provided to the user through the program list 230.

The program list 239 can also be used to provide program information to a user during playback. For example, program titles and running lengths can be provided to a user during playback. A current program being played can be highlighted to a user's attention, such as the emboldened PROGRAM3 in the illustrated embodiment, while providing information regarding programs recorded before and after the current program. Furthermore, a program synopsis 250 can be provided to the user to indicate a summary of the current program.

A user can select a program from the program list 239 through the use of a cursor 240, such as a mouse cursor. Alternatively, a slider 220 can be provided to the user. A user can move the slider 220 to select a current program. For example, as a user moves slider 220, the program title of the program currently selected by slider 220 can be emboldened and the synopsis of the program can be displayed on program synopsis 250. Accordingly, by moving slider 220, a user can scan through the N programs stored in the selected video stream. It should be appreciated that other information can be provided to the user regarding the programs stored in the selected video stream. For example, a channel and a data/time can be provided for each of the programs. Furthermore, other methods of selecting programs from the video stream can be used without departing from the scope of the present invention.

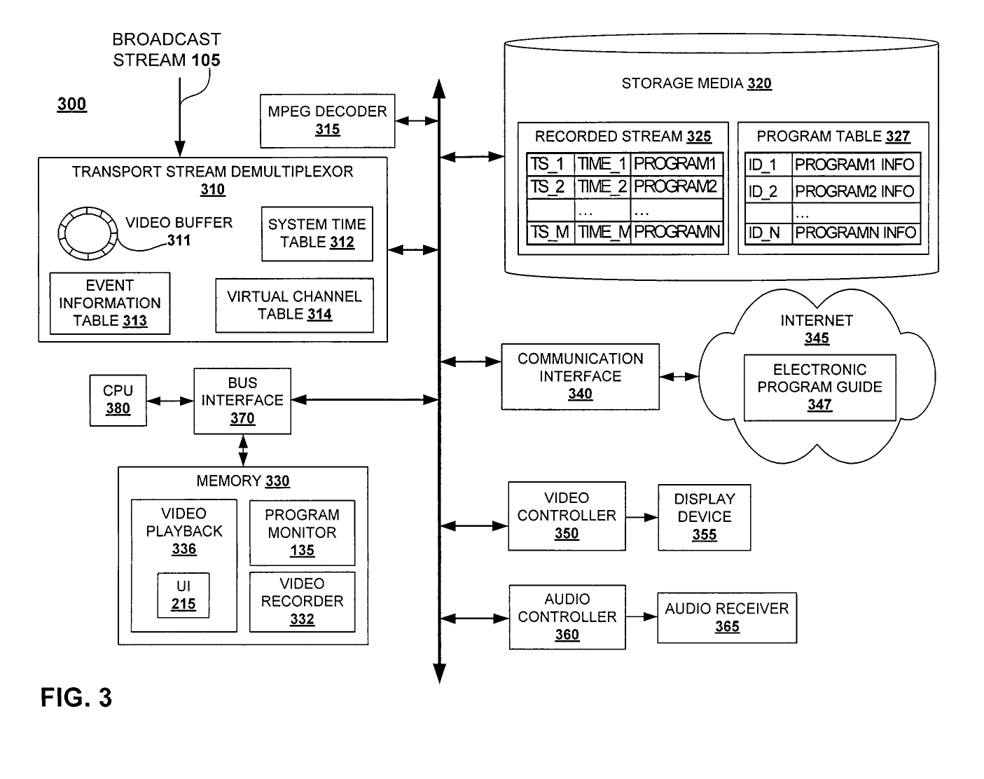

Referring now to FIG. 3, a block diagram illustrating the system of FIG. 1 in more detail is shown and referenced generally as system 300, according to one embodiment of the present disclosure. System 300 includes a transport stream demultiplexor 310, an MPEG decoder 315, storage media 320, memory 330, a communication interface 340, a video controller 350 coupled with a display device 355, an audio controller 360 coupled with an audio receiving device 365, a bus interface 370 and a central processing unit (CPU) 380.

In operation, transport stream demultiplexor 310 is used to receive digital video streams from a broadcast stream 105. The MPEG decoder 315 generates video and audio data from the video stream identified by the transport stream demultiplexor 310. The video stream can also be stored as recorded stream 325 in storage media 320. An application, such as program monitor 135, run through CPU 380, or other portion of the system 300, identifies separate programs associated with the audio and video data being stored. The program monitor 135 stores the program information as program table 327 in storage media 320. System 300 allows program information to be stored in conjunction with a video stream being recorded. The program information can be used by a user to identify particular programs associated with a recorded multimedia stream, such as recorded stream 325. Further operation of individual components of system 300 is discussed below.

Transport stream demultiplexor 310 parses the broadcast stream 105 to identify a particular video stream requested by a user. A system time table 314 determines a system time, synchronized to information available through the broadcast stream 105, and reports the time to other components of system 300. The system time table 314 can be used for ensuring proper playback of video streams based on timing embedded in the broadcast stream 105. The virtual channel table 314 identifies attributes, received through the broadcast stream 105, associated with virtual channels in the received broadcast stream 105. The event information table 313 collects information, parsed from the broadcast stream 105, related to events or programs on the virtual channels. The video buffer 311 is used to store the particular video stream being processed by the transport stream demultiplexor 310 for output. In one embodiment, the video buffer 311 is a ring, or circular, buffer.

The MPEG decoder 315 processes MPEG encoded data from the video stream output by the transport stream demultiplexor 310. The MPEG decoder 315 processes the video stream into digital video data capable of being processed by the video controller 350 for output to a display device 355. The MPEG decoder 315 is also capable of generating audio data to be processed by the audio controller 360 for output to an audio receiving device 365 or audio speakers (not shown).

It may be desired to store the video stream for playback at a later time. A video-recording device or application, such as video recorder 332, can be used to store the video stream in a form of media, such as storage media 320, for future playback. In one embodiment, CPU 380 runs video recorder 332 from memory 330, through bus interface 370. It should be noted that memory 320 represents a memory device, such as a random access memory (RAM) device or component. Video recorder 370 stores video stream data stored in video buffer 311. The video stream is stored as recorded stream 325 and include video stream data which can be decoded by the MPEG decoder 315 at a later time for output through video controller 350 and audio controller 360. As the current program being processed by the transport stream demultiplexor 310 can change depending on the time or virtual channel selected, multiple programs can be stored in the recorded stream 325. In the illustrated embodiment, N programs are stored as part of recorded stream 325, which represents a continuously recorded video stream.

Along with the video stream data associated with the multiple programs, other information may also be stored in the recorded stream 325. For example, timestamps, used for identifying relative times at which portions of the recorded stream 325 are to played back. Furthermore, dates/times when portions of the recorded stream 325 were received can also be stored. It should be noted that multiple timestamps and date/time information can be recorded for each of the portions of the recorded stream 325 relating to particular programs. In the illustrated embodiment, M timestamps and date/time data sets are stored in the recorded stream 325.

A monitoring application, program monitor 135, is used to track information about each of the different programs stored in the recorded stream 325. The program monitor 135 detects programming changes in the video stream being recorded as recorded stream 325. The changes detected can include, but are not limited to, changes in a selected channel and changes in the name or description of the current program. Furthermore, the program monitor 135 can detect changes when a new signal input is used for generating the video stream, such as switching to a different video source, or video demodulator. In one embodiment, the program monitor 135 monitors the title of the current program being recorded to determine if a change in programming has occurred. In one embodiment, the program monitor 135 identifies the current program being recorded by matching a current channel selected by a user to the virtual channel table 314 and the event information table 313 to identify the title of the program scheduled for that channel at the current time. Alternatively, the program monitor 135 can access an electronic program guide 347. In one embodiment, the electronic program guide 347 is accessed from a network, such as the Internet 345, using a communication interface 340. Furthermore, the program monitor 135 can monitor vertical blanking interval (VBI) data sent with the video stream being stored or with the broadcast stream 105. For example, the program monitor 135 can monitor closed-captioning data being received to identify when one program ends and a new program begins.

It should be appreciated that other methods of detecting changes in programming in addition to or in place of the methods discussed can be used without departing from the scope of the present invention. In one embodiment, a digital video processing component, such as MPEG decoder 315 or video recorder 332, can be used to identify a scene change in the video stream being recorded as recorded stream 325. A detected scene change can be used in place of or in addition to other program change detection techniques. Alternatively, a program change can be induced after a set amount of time, such after thirty-minute intervals, to identify thirty-minute program segments.

In response to the detected change, the program monitor 135 stores information associated with the program being recorded. For example, the program monitor 135 can store the program information in program table 327. In one embodiment, a set of program information is stored for each detected program in the recorded stream 325. The set of program information can include, but is not limited to, plot synopsis, program title, channel name, program rating, or program duration. Program information stored in the program table 327 can be identified through data parsed from the broadcast stream 105, such as through the event information table 313, through received VBI data, or through the electronic program guide 347. The program monitor 135 can associate each of the sets of program information stored in the program table 327 with each detected program of the recorded stream 325. For example, the program monitor 135 can generate unique identifiers for each of the sets of program information. The unique identifiers can be generated so as to allow the program information to be matched to a portion of the recorded stream 325 associated with the particular program. For example, the identifiers can be generated to mark date/time information or timestamps stored in the recorded stream 325. Alternatively, the identifiers can mark positions of the recorded stream 325 which are used to store particular programs.

A playback application, video playback 336, can be used for playback of the recorded stream 325 for a user. A user interface 215 is provided to the user to allow the user to identify programs stored in the recorded stream 325. For example, once the user selects the recorded stream 325 for playback, the user interface 215 can present the program information in the program table 327 to the user for each of the detected programs in the recorded stream 325. The user can then select a particular program based on the program information and the portion of the recorded stream 325 associated with the particular program can be played back by video playback 336. Furthermore, program information for a current program of the recorded stream 325 being played by video playback 336 can be presented as multiple portions of the recorded stream 325 are played.

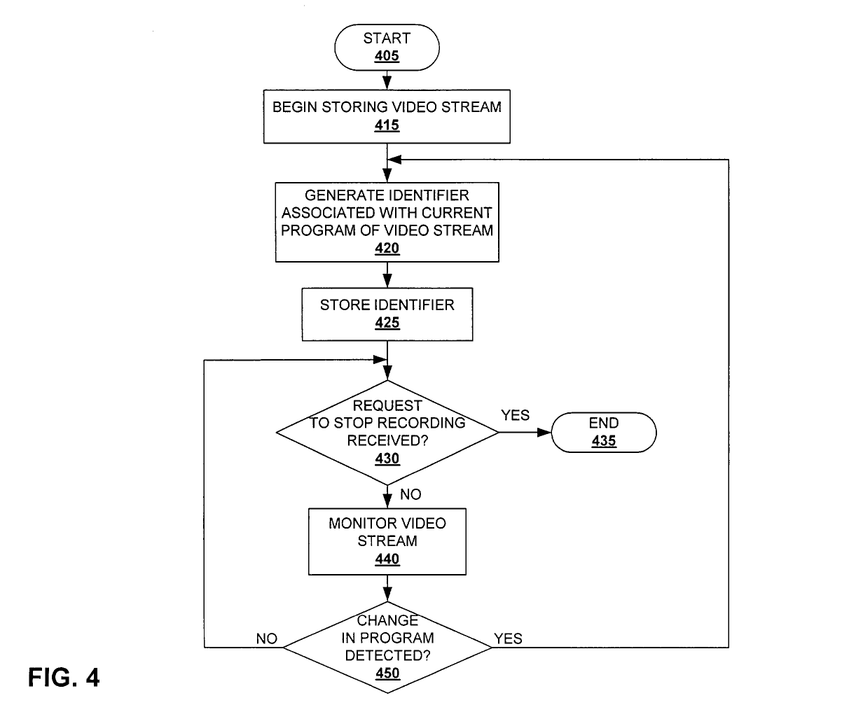

Referring now to FIG. 4, a flow diagram illustrating a method of recording a multimedia stream is shown, according to one embodiment of the present disclosure. The illustrated method allows for the storage of program information related to different programs being recorded as part of a continuous recorded video stream.

In step 405, the process begins. For example, a request to record a video stream currently being decoded can be received to start the procedure. In step 415, the recording of the video stream begins. In one embodiment, the video stream is a digital video stream. Accordingly, the video stream can be recorded by storing the digital video stream data in a form of memory storage, such as storage media 320 (FIG. 3).

In step 420, an identifier associated a current program of the video stream is generated. Step 420 can include identifying a current program, such as by accessing an electronic program guide or monitoring data received with the video stream, such as in broadcast stream 105. The identifier should be generated so as to allow the current portion of the video stream being recorded to be recognized. For example, in one embodiment, timestamps stored with the video stream are used to generate the identifier. Accordingly, the current portion of the video stream being recorded can be identified at a later time using the stored timestamps. In step 425, the identifier is stored. The identifier is stored with program information associated with the current program of the video stream being recorded. Accordingly, the identifier is used to link the program information to the portion of the video stream the program information is associated with.

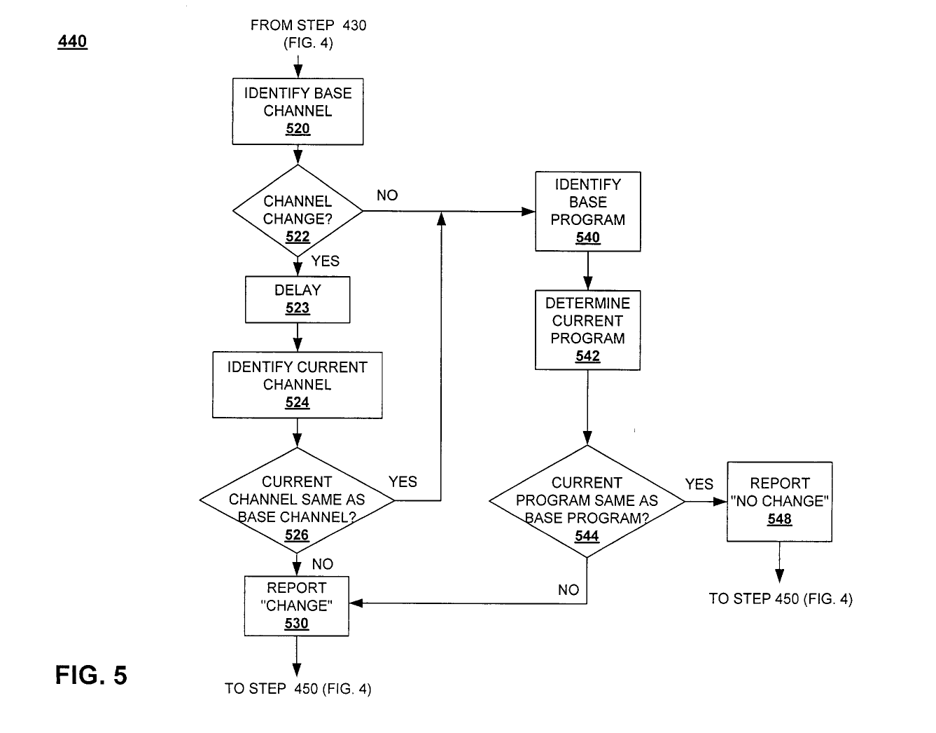

In step 430, it is determined if a request to stop recording has been received. The request can be generated by a user. Alternatively, the recording of the video stream could have been scheduled by the user and an end of the scheduled recording time has been reached. In step 435, if the request to stop recording was received, the recording session ends and the storage of the video stream is completed. In step 440, if a request to stop recording was not received, the video stream is monitored to identify any changes in programming. In step 450, it is determined if a change in programming has occurred. If no change in programming was received from step 440, the flow returns to step 430 to determine if the request to end the recording session was received. If a change in programming was detected, the flow returns to step 420 to generate a new identifier to link new program information with the new program being recorded in the video stream. It should be noted that several methods of monitoring the video stream being recorded can be used to identify changes in programming. Accordingly, step 440 is shown in FIG. 5 in more detail to further describe a couple of methods that can be employed. It should be appreciated that other methods can be used without departing from the scope of the present invention.

Referring now to FIG. 5, a flow diagram illustrating step 440 of FIG. 4 in more detail is shown, according to one embodiment of the present disclosure. Several methods exist for providing detecting changes in programming. One method includes identifying changes in programming based on channel changes. Another method includes identifying changes in programming based on changing program titles. Other methods of identifying changes in programming can be used, in addition to or in place of the methods described herein, without departing from the scope of the present disclosure.

In the illustrated embodiment, a channel-based detection of programming change is performed first (steps 520, 522, 523, 524 and 526) followed by a program-based detection of programming change (steps 540, 542 and 544). In step 520, a base channel is identified. The base channel represents the last known channel selected. The base channel can be identified from the initial channel used when an initial request to record the video stream was received or from a previous detection of a current channel selected by the user. In step 522, it is determined if a channel change occurred. The channel change can be triggered by the user selecting a different channel or an electronically scheduled channel change. If no channel change occurred, the flow proceeds to step 540 to attempt another method of detecting a change in programming. Alternatively, if a channel change was detected in step 522, the flow proceeds to step 523.

In step 523, a delay is processed. The delay maintains a period of time before the flow proceeds to the next step, step 524. As a change in channel has occurred, the delay will provide the user a length of time, such as for “channel surfing” before the system decides the channel change is indicative of a change in programming. In one embodiment, the delay is reset when a new channel change request is received, ensuring the user settles on a channel before with the flow. In step 524, the current channel is identified. In step 526, the current channel is compared to the base channel. For example, the channel numbers of the base channel and the current channel are compared. If the channels do not match, the flow proceeds to step 530. In step 530, a “change” signal is provided for step 450 (FIG. 4). The “change” signal indicates a change in programming has been detected. Alternatively, if the current channel matched the base channel in step 526, no change in programming due to channel changing is identified. Therefore, of the base channel and the current channel match in step 526, the flow proceeds to attempt to identify a change in programming by another method, as in step 540.

In step 540, the base program is identified. The base program can represent either the last known program or the program identified upon system startup. Stored program information can be used to identify the base program. In step 542, the current program is identified. The name of the current program can be identified through program information associated with the current program, or through VBI information. In step 544, the current program is compared to the base program. If the current program is the same as the base program, no change in programming is detected and the flow proceeds to step 548. In step 548, a “no change” is reported for step 450. The “no change” indicates no change in programming has been detected for the types of changes tested. It should be appreciated that other method of detecting a change in programming can be employed in addition to, or in place of, the methods of change detected.

What is claimed is:

1. A method of recording a received video stream as a recorded video stream comprising:
storing the received video stream as a recorded video stream;
associating a first portion of the recorded video stream with a first identifier, wherein the first identifier represents a first portion of the received video stream;
detecting a change in programming associated with the received video stream, wherein the change in programming represents a change from the first portion of the received video stream and a second portion of the received video stream; and
associating, in response to the step of detecting, a second portion of the recorded video stream with a second identifier, wherein the second identifier represents the second portion of the received video stream.

2. The method as in claim 1, further comprising:
receiving a user request for playback of a portion of the recorded video stream, wherein the user request includes the second identifier;
identifying the second portion of the recorded video stream based upon the second identifier; and
presenting the second portion of the recorded video stream based upon the step of identifying.

3. The method as in claim 1, further comprising:
storing the first and second identifier;
associating a first set of program information with the first identifier, wherein the first set of program information represents information about the first portion of the received video stream; and
associating a second set of program information with the second identifier, wherein the second set of program information represents information about the second portion of the received video stream.

4. The method as in claim 3, wherein the first set of program information and the second set of program information each include a program name.

5. The method as in claim 3, wherein the first set of program information and the second set of program information each include a program synopsis.

6. The method as in claim 3, further comprising:
providing playback of the recorded video stream;
when playback of the recorded video stream includes playback of the first portion of the recorded video stream:
using the first identifier to provide the first set of program information to a user; and
when playback of the recorded video stream includes playback of the second portion of the recorded video stream:
using the second identifier to provide the second set of program information to the user.

7. The method as in claim 1, wherein the first identifier includes a time the first portion of the received video stream was stored and the second identifier includes a time the second portion of the received video stream was stored, wherein the first time and the second time are different.

8. The method as in claim 1, wherein the first identifier includes a first location of the first portion of the recorded video stream and the second identifier includes a second location, different from the first location, of the second portion of the recorded video stream.

9. The method as in claim 1, wherein the first identifier includes a first timestamp associated with the first portion of the received video stream and the second identifier includes a second timestamp associated with the second portion of the received video stream.

10. The method as in claim 1, wherein the step of detecting the change in programming includes identifying a between a channel used to provide the first portion of the received video stream and a channel used to provide the second portion of the received video stream.

11. The method as in claim 1, wherein the step of detecting the change in programming includes identifying a change between a program name associated with the first portion of the received video stream and a program name associated with the second portion of the received video stream.

12. The method as in claim 11, wherein the name of a program associated with a portion of the received video stream is identified through an electronic program guide.

13. The method as in claim 11, wherein the name of a program associated with a portion of the received video stream is identified through vertical blanking information associated with the received video stream.

14. The method as in claim 1, wherein the step of detecting the change in programming includes identifying a change between a first source used to provide the first portion of the received video stream and a second source used to provide the second video stream.

15. The method as in claim 1, wherein the received video stream includes a digital video stream.

16. The method as in claim 15, wherein the digital video stream includes a Motion Pictures Experts Group digital video stream.

17. A system comprising:
a processor having an input/output buffer;
memory coupled to said input/output buffer of said processor;
at least a first video receiver to provide a received video stream having a first portion and a second portion;
a program monitor to identify a change from a first characteristic associated with the first portion of the received video stream to a second characteristic, associated with the second portion of the received video stream;
a video recorder to:
store the received video stream as a recorded video stream;
store a first identifier to be associated with a first portion of the recorded video stream, wherein the first portion of the recorded video stream is related to the first portion of the received video stream;
store a second identifier to be associated with a second portion of the recorded video stream, wherein the second portion of the recorded video stream is related to the second portion of the received video stream.

18. The system as in claim 17, wherein the first identifier is stored with a first set of program information, wherein the first set of program information includes information associated with the first portion of the received video stream and further wherein the second identifier is stored with a second set of program information, wherein the second set of program information includes information associated with the second portion of the received video stream.

19. The system as in claim 18, further including:
a video playback device to
provide playback of the recorded video stream;
present the first set of program information, using the first identifier, when the first portion of the recorded video stream is being played; and
present the second set of program information, using the second identifier, when the second portion of the recorded video stream is being played.

20. The system as in claim 19, wherein the video playback device includes an application to be run from said memory.

21. The system as in claim 17, wherein the first portion of the received video stream is to include a first program and the second portion of the received video stream is to include a second program.

22. The system as in claim 17, wherein the first characteristic is associated with a first channel used to provide the first portion of the received video stream and the second characteristic is associated with a second channel, different from the first channel, used to provide the second portion of the received video stream.

23. The system as in claim 17, wherein the first characteristic is associated with a first program name representative of the first portion of the received video stream and the second characteristic is associated with a second program name, different from the first program name, representative of the second portion of the received video stream.

24. The system as in claim 17, wherein the first characteristic is associated with a first source used to provide the first portion of the received video stream and the second characteristic is associated with a second source, different from the first source, used to provide the second portion of the received video stream.

25. The system as in claim 17, wherein the program monitor is run from said memory.

26. The system as in claim 17, wherein the video recorder is run from said memory.

27. A system comprising:
a video application to provide playback of a recorded video stream, wherein the recorded video stream includes a first portion associated with a first program and a second portion associated with a second program, and further wherein the recorded video stream is associated with a program table;
said program table comprising a first set of program information associated with the first program and a second set of program information associated with the second program;
a user interface to provide program information from said program table based on a selection of the recorded video stream for playback in said video application, said application programming interface including:
a window to display at least said first set of program information when the first portion of the recorded video stream is being played back and at least said second set of program information when the second portion of the recorded video stream is being played back.

28. The system as in claim 27, wherein said program table includes a first identifier to link said first set of program information with said first portion of said recorded video stream, and a second identifier to link said second set of program information with said second portion of said recorded video stream.

29. The system as in claim 27, wherein said user interface used to provide the first and second set of program information to a user when the recorded video stream is selected for playback.

30. The system as in claim 29, wherein said user interface allows a user to select a set of program information to initiate playback of an associated portion of the recorded video stream.

31. The system as in claim 27, wherein said user interface used to provide a scroll bar, wherein said scroll bar allows user to identify separate sets of program information associated with the recorded video stream.

32. The system as in claim 30, wherein said scroll bar further used to playback portions of the recorded video stream associated with the separate sets of program information identified by the user.

33. The system as in claim 27, wherein the first set of program information includes a program name associated with the first program and the second set of program information includes a second program name associated with the second program.

34. The system as in claim 27, wherein the first set of program information includes a description of the first program and the second set of program information includes a description of the second program.
